(19) United States
(12) Patent Application Publication
(10) Pub. No.: US 2012/0112598 A1
(43) Pub. Date: May 10, 2012

(54) ELECTRICAL MACHINE STATOR ASSEMBLY

(75) Inventor: Timothy Scott Germann, Auckland (NZ)

(73) Assignee: WELLINGTION DRIVE TECHNOLOGIES LIMITED, Auckland (NZ)

(21) Appl. No.: 13/383,096

(22) PCT Filed: Jul. 6, 2010
(86) PCT No.: PCT/NZ2010/000141

§ 371 Date: Jan. 9, 2012

(30) Foreign Application Priority Data
Jul. 9, 2009 (NZ) 578288

(51) Int. Cl. H02K 1/06; H02K 15/04

(52) U.S. Cl. 310/216.008; 29/596; 310/216.001

(57) ABSTRACT

An electrical machine such as a motor has a stator on which toroidal coils are mounted on a segmented backiron. The segments overlap to produce a graded magnetic flux at the joint between two segments, and the number of segments and the position of the joints with respect to the phases of the machine coils and the poles of the rotor are such that the flux joints are distributed evenly across the phases and the poles while allowing assembly of the machine backiron with the coils mounted on the segments. This results in a motor with no sudden flux changes in the stator and therefore reduced cogging and incipient noise.

### TECHNICAL FIELD

The invention generally relates to stators for electrical or electrodynamic machines. More particularly the invention relates to stators for electrical motors and generators where the stator carries windings supported on a toroidal back iron.

### BACKGROUND ART

Motors or generators where the windings are supported on a ferromagnetic substantially toroidal back iron are known. Such machines use less iron than a typical radial pole machine but provide difficulties in either placing the windings on the ferromagnetic core or in placing the core within the windings.

It is known to wind windings on a toroidal core, whether with or without bobbins, by using a special winding machine which, effectively, rotates through and around the toroidal core. Similarly it is known to place the core within a series of wound bobbins by threading wound bobbins on through a gap in the core, this gap being left open, or closed by bending the core.

Motor designs of this type are described in U.S. Pat. No. 4,103,197, U.S. Pat. No. 7,145,280 and U.S. Pat. No. 7,391,294. Specific backiron cores suitable for such construction are described in U.S. Pat. No. 4,103,197 and U.S. Pat. No. 7,145,280.

Leaving a gap in a core provides a discontinuity in the magnetic flux at this point, which reduces efficiency and tends to aggravate cogging of the motor, making it move with regular jerk overlays on the smooth torque and creating noise. Bending the core requires the core to be flexible in the radial direction, which requires a core material having a less favourable cost performance ratio than conventional stacked laminations.

It is also known to thread wound bobbins onto a number of core segments which are subsequently assembled into a completed core. However joints between segments inevitably cause discontinuities in the magnetic flux due to imperfections in fit. In known approaches to this method the segments are joined in the gaps between windings. This results in the discontinuities being unevenly magnetically distributed, causing variations in magnetic circuit reluctance as the rotor rotates. This again causes cogging and vibration. Japanese specifications 2008-259399, H01-138937 and S55-157964 show salient pole motors of this type and have projections to assist in preventing relative movement between segments.

It is also known to extend the abutment length in such a method to cover a complete magnetic pole of the rotor, so that the flux variation as the rotor is moved can be much reduced. However for numbers of poles less than 16, the angle subtended by a complete pole is large enough to make a joint of this length impractical to manufacture and assemble without flexing the core.

Therefore a need exists for a solution to the problem of how to provide a method of providing a wound stator with toroidal windings which is easy to wind and assemble, and which does not cog or create noise.

### OBJECT

It is an object of this invention to provide a solution to this and other problems which offers advantages over the prior art or which will at least provide the public with a useful choice.

### DEFINITIONS

Within this specification the term “mechanical degree” refers to one degree of measurement about the rotational axis of the machine. A full rotation of a rotor is therefore 360 mechanical degrees.

Within this specification the term “electrical degree” is twice the number of mechanical degrees in a given angle divided by the number of poles on the machine. Thus in a six pole machine 360 electrical degrees occupy 120 mechanical degrees and 180 electrical degrees occupy 60 mechanical degrees. The term describes the theoretical rotation angle of a motor or generator in 1/360 of the time required for one complete cycle of alternating current to occur.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in a method of assembling an electrical machine stator with multiple winding parts supplied in use by at least two phases by providing at least two core portions which when assembled form a toroidal core with configurations which limit engagement of the core portions with each other and limit excursions of one core portion relative to the other in a radial direction with respect to the axis of the core, mounting about each core portion at least one winding part and assembling the core portions together by movement in a plane normal to the machine rotational axis, the abutting configurations for the core portions falling equally in each phase of the winding parts such that the sum of the circumferential lengths of the configurations will always be substantially the same for any 180 electrical degrees of the stator and that sum approximates a multiple (including one) of 180 electrical degrees.

Preferably the abutting configurations are distributed substantially evenly across 180 electrical degrees of the motor magnetic circuit.

Preferably limiting the engagement of the core portions is provided by engagement of a circumferentially projecting portion of a core portion with a re-entrant portion on the corresponding engaging portion of the adjacent core portion.

Preferably the core portions are laminations.

Preferably the core portions for a single stator layer are manufactured as conjoined segments in a continuous chain and are assembled as a stator layer by relatively bending the conjoined chain.

Preferably the core portions for a single stator layer are manufactured as conjoined segments in a continuous chain and are assembled as a stator layer by breaking the conjoined chain and locating the previously chained portions adjacent each other.

In an alternative embodiment the invention consists in a wound core for an electrical machine stator to interact with a rotor with multiple poles and consisting of at least two core portions which when assembled form a toroidal core, each core portion having configurations which limit engagement of the core portions with each other and limit excursions of one core portion relative to the other in a radial direction with respect to the axis of the core, each core portion having one or more windings, the core portions being of a length such that the engagement limiting configurations for the core portions fall equally within each phase of the stator and the configurations of the adjoining region of each core portion overlap with the next core portion such that the sum of the overlaps approximates a multiple of 180 electrical degrees.

Preferably, were the core portions of each 180 electrical degrees overlaid, the overlaid overlaps would appear equally distributed across the 180 electrical degrees.

Preferably the stator is assembled from core portions with mounted stator coils, the configurations of the core portions being such that the stator can be assembled by movement normal to the stator axis.

Preferably the engagement of the core portions is limited by engagement of a circumferentially projecting portion with a re-entrant portion on the corresponding engaging portion of the adjacent core portion.

Preferably the core portions are laminations.

Preferably the core portions for a single layer lamination initially consist of a chain of conjoined core portions.

Preferably the conjoined core portions are assembled into a core layer by relative bending motion.

Preferably the conjoined core portions are broken apart at deformable necks between the core portions and reassembled.

In a further embodiment the invention consists of an electrical machine having a rotor having multiple poles adjacent a stator consisting of multiple core portions assembled in the form of a toroidal core, each core portion having configurations which limit engagement of the core portions with each other and limit excursions of one core portion relative to the other in a radial direction with respect to the axis of the core, each core portion having one or more windings, the core portion lengths being such that the configurations for the core portions fall equally within each phase of the stator, the configurations of the abutting region of each core portion overlapping with the next core portion such that the sum of the overlaps approximates a multiple of 180 electrical degrees.

Preferably, were the core portions of each 180 electrical degrees overlaid, the overlaid overlaps appear equally distributed across the 180 electrical degrees.

Preferably the electrical machine stator is assembled from core portions with mounted stator coils, the configurations of the core portions being such that the stator can be assembled by movement normal to the stator axis.

Preferably the rotor and stator are axially aligned in a discoidal configuration

Preferably the core portions are of equal lengths.

Preferably the core portions are of at least two differing lengths.

These and other features of as well as advantages which characterise the present invention will be apparent upon reading of the following detailed description and review of the associated drawings.

### BRIEF DESCRIPTION OF THE DRAWINGS

FIG. 1 is a diagrammatic plan view of an electric motor according to the invention.

FIG. 2 shows a plan view of a possible stator core for the motor of FIG. 1.

FIG. 3 is a plan view of a more useful form of the stator core for the motor of FIG. 1.

FIG. 4 is a plan view of the core of FIG. 3 with the core split apart.

FIG. 5 is a view of the core of FIG. 1 taken in the sense of 180 degrees of each phase.

FIG. 6 is a view of the core of FIG. 1 taken in the sensor of 360 degrees of each phase.

FIG. 7 shows an example perspective view the motor of FIG. 1.

FIG. 8 shows an example perspective view in one direction of the stator of FIG. 1 split for assembly.

FIG. 9 shows the same view as FIG. 8 from a different direction.

FIG. 10 shows a series of laminations as stamped from sheet material.

### DESCRIPTION OF THE INVENTION

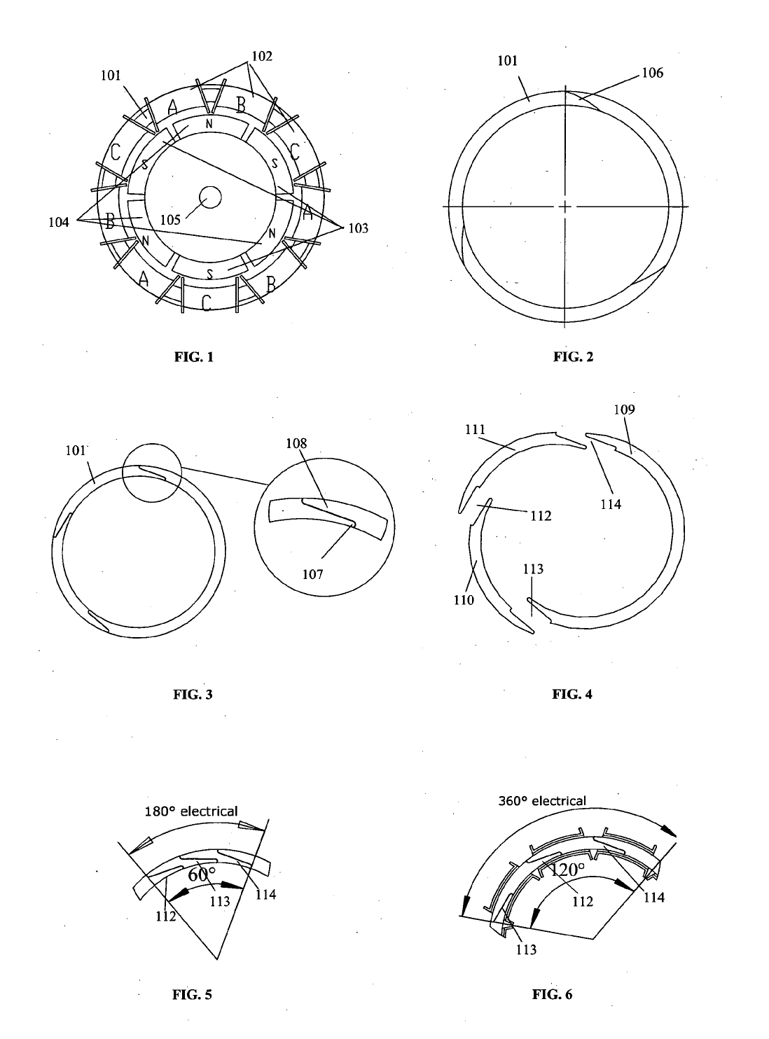

Referring now to FIG. 1 this shows a plan view of a six pole motor with three phases. The poles are formed by pairs of south outwards magnets 103 and north outwards magnets 104. The phases are provided by three sets of the three phases 102 on toroidal bobbins A, B and C on a ferromagnetic or ferrimagnetic stator core 101, so that there is a set of three phases for each consecutive set of two magnets. Each bobbin of a phase will subtend two-thirds of the width of a pole magnet and 360 electrical degrees will subtend the three bobbins of a phase set, or 120 mechanical degrees. The magnets may be ferritic ceramic, rare earth or iron based.

To allow assembly of the core with the bobbins already in place the core 101 may be assembled in segments as described in the known prior art. Such segments typically are joined by simply abutting the radial faces of the segments, or using axially assembled dovetail joints. In either case this leaves at least two radial air gaps in the core where segments do not fit perfectly. These radial air gaps act as an abrupt change in the magnetic permeability of the core and an area of higher magnetic reluctance in the core. This change in magnetic flux produces a change in the electromotive force on the rotor of an electric motor which results in a tendency of the rotor to slow down abruptly at the interface and speed up abruptly after it, known as “cogging”. This naturally produces noise from the changes in revolution rate and also produces vibrations which can add to the fatiguing of wires and the fretting of component parts. In the case of salient pole machines, such cogging is small compared with that produced by the poles themselves: However in the case of a machine with a toroidal stator, no pole cogging occurs so this effect is noticeable.

FIG. 2 shows one possible core 101 for reducing this effect in such a motor or generator. This has involute shaped extended abutments between segments of the core, these giving an extended air gap of constant width which produces a much slower change in reluctance.

The involute jointed cores such as shown are difficult to assemble, since there is no clear position in which the core alignment is positively set, and additionally are difficult to manufacture and handle due to the sharp corners and thin sections, particularly if the abutment length is long relative to its radial thickness and if the core is of thin metallic laminations.

FIG. 3 shows a variation in which the ends of the core laminations or segments are shaped with a slightly returned portion at 107 which ensures that if the ends of two laminations or segments are butted together they will positively locate. This allows a radially inwards pressure to be placed on the exterior of the core which acts to hold the core together, while the length of the abutment distributes the disturbed flux over a larger angular sector of the circumference. This, of itself results in reduced cogging and thus provides less noise.

The abutment shape shown is only one example of the shapes which will provide a self-limiting abutment of the laminations or segments, however the aim is to provide an abutment shape or configuration which has as regular an air gap as possible when the segments are assembled and which will limit and tend to maintain the alignment of the segments once in position. As minimum cogging requires the length of the abutment to be large relative to the gap between windings, it is not practical to assemble the segments with the coils fitted to them using an axial motion. Abutment configurations which might require movement normal to the plane of the laminations or segments are therefore best avoided.

FIG. 4 shows the three components 109, 110, 111 of the core which overlap at 112, 113, and 114 with segments which are one of two differing sizes. Segment 109 carries five bobbins while each of segments 110 and 111 carries two bobbins. It should be noted that with segments 110 and 111 assembled together the remaining segment may be fitted to these with virtually a straight line motion. For minimum flux variation it is important that the same number of flux interruptions occur in each phase of the stator, although it is unimportant to flux variation whether the interruptions occur within adjacent coils of the separate phases or are spaced within coils in a different set of phase coils.

Therefore the length of the segments is calculated to place an equal number of joins or air gaps in each phase of the motor or generator, so that each phase is equally affected by the joins. It should be noted that although in this example the number of coils in each phase is equal to the number of magnetic pole pairs; other phase configurations are possible where this is not the case.

Additionally, the length of the joins and their distribution is calculated to be such that each pair of poles on the rotor is equally affected by the joins at any one time, or in other words, as the rotor revolves there will always be substantially the same length of joint present within any 180 electrical degree section of the electromagnetic circuit.

The calculations described above yield a restricted number of preferred solutions, which require either that the segments are of unequal length or that the number of segments is not a multiple or submultiple of the number of poles. Non-preferred solutions either do not satisfy the calculations or require a disproportionately long abutment length. For phase distributions other than one phase set per pole, not all solutions which satisfy the first calculation also satisfy the second.

FIG. 5 shows a diagrammatic 60 degree portion of the stator onto which are overlaid the joint features from other portions of the stator in accordance with the pole location of the rotor at a particular rotational time. For this purpose the portion of the core adjacent each separate pole is shown as superimposed on all the other poles. As can be seen the number and disposition of the flux interrupting joints are substantially equally distributed across the 180 degrees of electrical flux meaning that each pole is substantially equally affected by the joints. This provides a substantially constant reluctance in each phase and at each pole thus providing reduced cogging of the rotor and reduced noise from the motor.

FIG. 6 shows a similar diagram in which the joint features from other portions of the stator are overlaid as for FIG. 4 but for a circumferential length equivalent to that subtended by a single set of phase coils (in this case this is equal to two adjacent poles). The joints now show as evenly separated over a 360 degree electrical separation of the joints over a 120 degree mechanical extent of the stator. This provides a substantially equal reduction in flux in each phase due to the joints, maintaining even balancing of the phases.

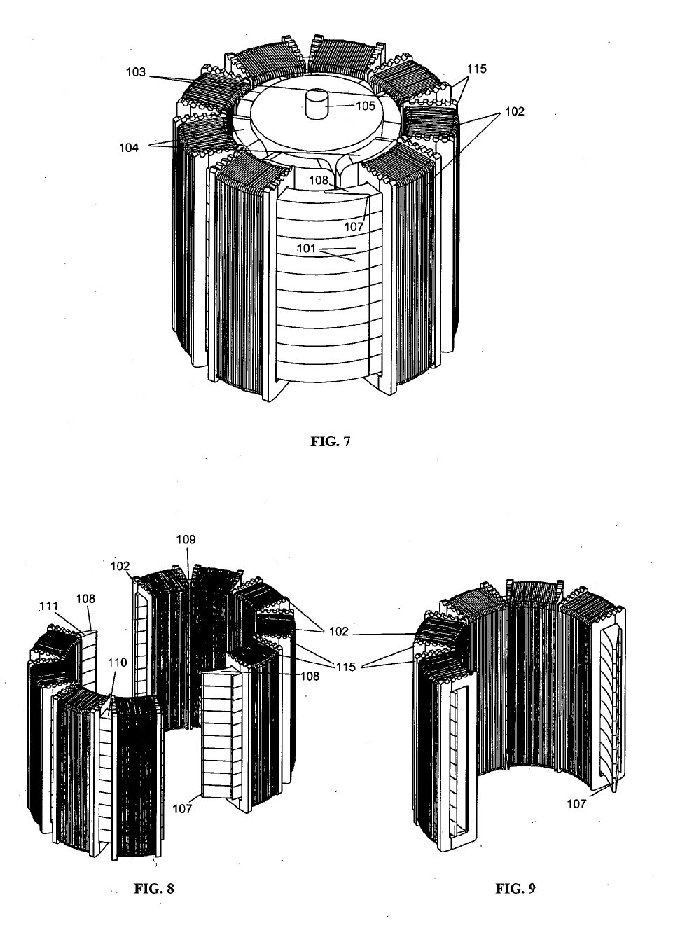

FIG. 7 shows a perspective view of the stator and rotor 105 with one coil removed from the stator to show the construction. The stator has coils 102 on toroidal bobbins 115 spaced equally around a stator core made up of segments 101 which may be stacked stamped iron laminations, or may equally be solid segments of sintered powder iron or other suitable soft magnetic material. Each segment has co-engaging shaped portions at 107, 108 as shown in FIG. 3 and the segments are all aligned so that the core may be aligned for assembly. Once assembled, the magnetic attraction between the stator and rotor will be sufficient to provide the necessary radial force to retain the segments in their interlocked position. Alternatively, and especially in the case of an external-rotor machine, other mechanical means may be necessary to provide this locking force.

FIG. 8 shows a partially assembled core with five bobbins 115 on core part 109, two bobbins on core part 110 and two more on core part 111 which is already assembled to core part 110. The tongues 108 of a core part projects ready to enter bobbins 102.

FIG. 9 shows a view of core part 109 which better demonstrates that the core projections 107 mate with recesses which are within the bobbin, requiring radial rather than axial assembly.

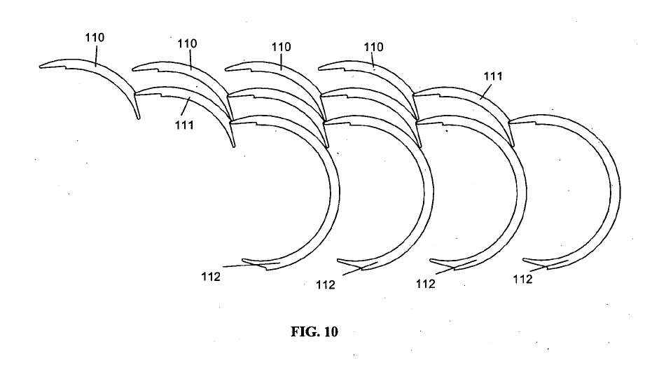

FIG. 10 shows lamination segments 110, 111, 112 as stamped from lamination material (albeit with a layout providing much waste). Each chain of segments is separate from every other chain, but each chain of segments 110, 111 and 112 has each segment connected to the other by a small neck of metal. This allows easier handling and assembly of the laminations.

### Variations

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the motor or generator may vary dependent on the particular application for which it is used without variation in the spirit and scope of the present invention.

In addition, although the preferred embodiments described herein are directed to a three phase stator for use in a motor, it will be appreciated by those skilled in the art that variations and modifications are possible within the scope of the appended claims.

### INDUSTRIAL APPLICABILITY

The electrodynamic machine of the invention is used as electrical motors or generators which are employed in industry and domestically. The present invention is therefore industrially applicable.

1. A method of assembling an electrical machine stator with multiple winding parts supplied in use by at least two phases by providing at least two core portions which when assembled about a machine rotational axis form a toroidal core with configurations which limit engagement of the core portions with each other and limit excursions of one core portion relative to the other in a radial direction with respect to the axis of the core, mounting about each core portion at least one toroidal winding part and assembling the core portions together by movement in a plane normal to the machine rotational axis, the abutting configurations for the core portions falling equally in each phase of the winding parts such that the sum of the circumferential lengths of the configurations will always be substantially the same for any 180 electrical degrees of the stator and that sum approximates a multiple (including one) of 180 electrical degrees.

2. A method as claimed in claim 1 wherein the abutting configurations are distributed substantially evenly across 180 electrical degrees of the motor magnetic circuit.

3. A method as claimed in claim 1 wherein the core portions for a single stator layer are manufactured as conjoined segments in a continuous chain and are assembled as a stator layer by relatively bending the conjoined chain.

4. A method as claimed in claim 1 wherein the core portions for a single stator layer are manufactured as conjoined segments in a continuous chain and are assembled as a stator layer by breaking the conjoined chain and locating the previously chained portions adjacent each other.

5. A wound core for an electrical machine stator to interact with a rotor with multiple poles and consisting of at least two core portions which when assembled form a toroidal core, each core portion having configurations which limit engagement of the core portions with each other and limit excursions of one core portion relative to the other in a radial direction with respect to the axis of the core, each core portion having one or more toroidal windings, the core portions being of a length such that the engagement limiting configurations for the core portions fall equally within each phase of the stator and the configurations of the adjoining region of each'core portion overlap with the next core portion such that the sum of the overlaps approximates a multiple of 180 electrical degrees.

6. A wound core for an electrical machine stator as claimed in claim 5 wherein the engagement of the core portions is limited by engagement of a circumferentially projecting portion with a re-entrant portion on the corresponding engaging portion of the adjacent core portion.

7. A wound core for an electrical machine stator as claimed in claim 6 wherein the core portions are constructed of laminations.

8. An electrical machine having a stator and a rotor, the rotor having multiple poles adjacent the stator, the stator having a wound core as claimed in claim 5.

9. An electrical machine as claimed in claim 8 wherein the rotor and stator are axially aligned in a discoidal configuration

10. An electrical machine as claimed in claim 8 wherein the core portions are of equal lengths.

11. An electrical machine as claimed in claim 8 wherein the core portions are of at least two differing lengths.
